(19) United States
(12) Patent Application Publication
(10) Pub. No.: US 2012/0040656 A1
(43) Pub. Date: Feb. 16, 2012

(54) ELECTRONIC DEVICE AND METHOD FOR CONTROLLING THE WORKING MODE THEREOF

(75) Inventors: CHUN-WEN WANG, Tu-Cheng (TW); CHIEN-HUANG CHANG, Tu-Cheng (TW); CHI-FAN HO, Tu-Cheng (TW)

(73) Assignee: HON HAI PRECISION INDUSTRY CO., LTD., Tu-Cheng (TW)

(21) Appl. No.: 13/106,880

(22) Filed: May 13, 2011

(30) Foreign Application Priority Data
Aug. 11, 2010 (CN) 201010250973.2

(51) Int. Cl. H04M 3/00

(52) U.S. Cl. 455/418

(57) ABSTRACT

An electronic device includes a display, a location-positioning module, a timer, a storage unit. The location-positioning module detects a current location. The timer determines current time. The storage unit includes a mode switch module. The mode switch module controls a current working mode based on the current location or the current time.

### BACKGROUND

1. Technical Field

The disclosure generally relates to an electronic device and a method for controlling the working mode of the electronic device.

2. Description of Related Art

When at home, at work, or on the way between home and work, a portable electronic device is usually employed for facilitating entertainment, such as reading news, enjoying movies or music, or doing business, such as video meeting, or document sharing. However, the user can only use one working mode of the electronic device. Thus, a smart electronic device is needed to facilitate the control of the working mode of the electronic device.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic device in one embodiment.

FIG. 2 is a block view of a meeting UI module.

FIG. 3 is a view of the meeting UI on a desktop of a display.

FIG. 4 to FIG. 9 are exemplarily views showing other UI on the desktop of the display.

FIG. 10 is a view showing a switch rule table of working mode of the electronic device in one embodiment.

FIG. 11 is a flow chart of a method, according to one embodiment, for controlling the working mode of the electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

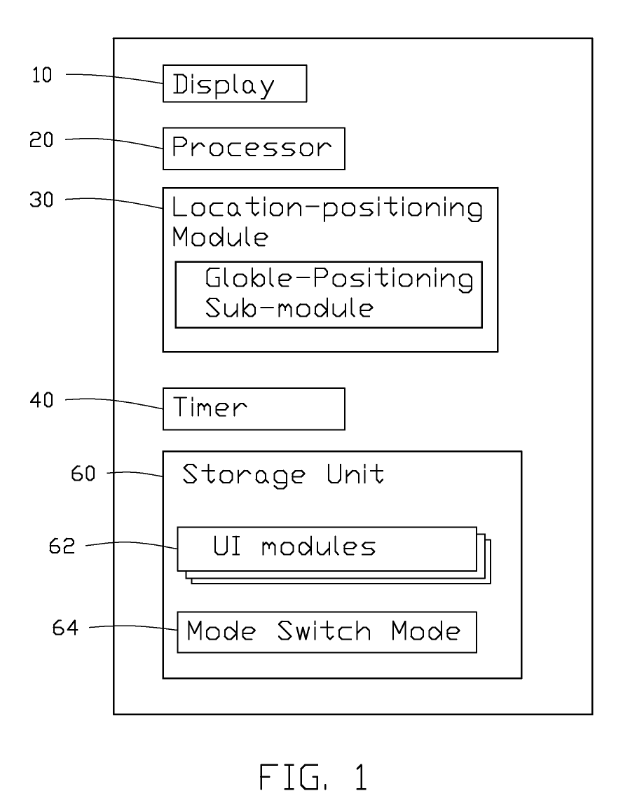

Referring to FIG. 1, in one embodiment, an electronic device includes a display 10, a processor 20, a location-positioning module 30, a timer 40 and a storage unit 60. The electronic device may be a portable electronic device, such as a smart phone. The display 10 may be a touch-sensitive display. The storage unit 60 includes a plurality of user interface (UI) modules 62, and a mode switch module 64.

A working mode of the electronic device can be invoked by one of UI modules from the plurality of UI modules 62. The plurality of UI modules may include a meeting UI module, a meditation UI module, a reading UI module, a social UI module, a document UI module, an entertainment UI module and a silence module. Each UI module may facilitate the user to access different functions of the electronic device. Each of the plurality of UI modules can be different in appearance when displayed.

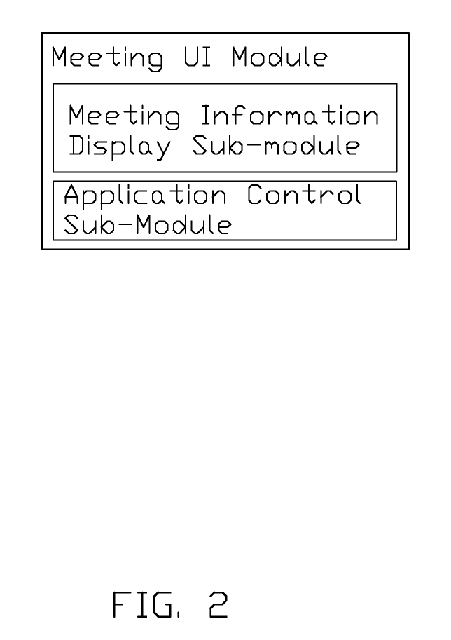

Referring to FIG. 2, in one embodiment, take the meeting UI module for example, the meeting UI module may include a meeting information display sub-module and an application control sub-module. The meeting UI module can be executed by the processor 20 to establish a meeting UI on the display 10.

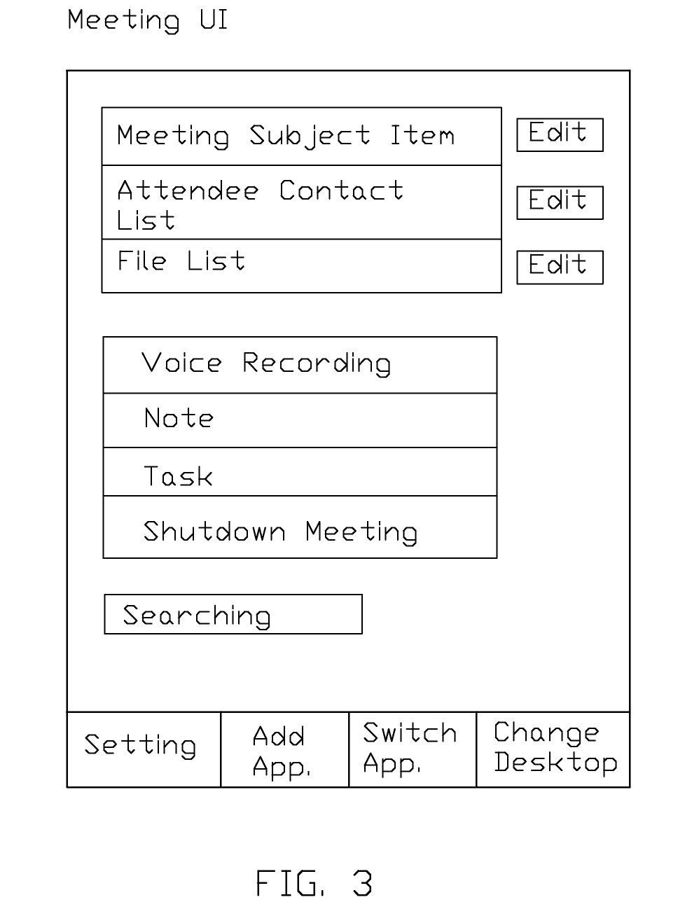

Referring to FIG. 3, a display meeting subject item, an attendee contact list and a file list are displayed on the meeting UI on a desktop of the display 10. The display meeting subject item, the attendee contact list and the file list are established by executing the meeting information display sub-module by the processor 20. The display meeting subject item displays information of a present or a forthcoming meeting subject or agenda. The attendee contact list may display abstract attendee information of the meeting. Detail attendee contact list may be shown when the attendee contact list is pressed. The detail attendee contact list may include email address list, or telephone number list. The detail attendee contact list may include a public attendee contact list and a private attendee contact list. An “Edit” button severs to edit the attendee contact list.

In one embodiment, the location-positioning module 30 may detect the location through a globe-positioning sub-module. The globe-positioning sub-module may detect the location of the electronic device through navigation satellites or other known means. The electronic device then may invoke the corresponding UI module, so that the current working mode may be changed to a new working mode depend on the corresponding UI module. For example, when a place within the company is detected, the meeting UI module may be invoked to display a meeting UI. When a place at home is detected, the entertainment UI module may be invoked to display an entertainment UI.

In one embodiment, the location-positioning module 30 may detect the location through an accessible wireless network connection device instead of globe-positioning sub-module. The accessible wireless connection device may be one of a plurality of wireless connection devices at work or at home. If no wireless devices or another wireless device is detected, the location may be recognized as on the way home or the way to work.

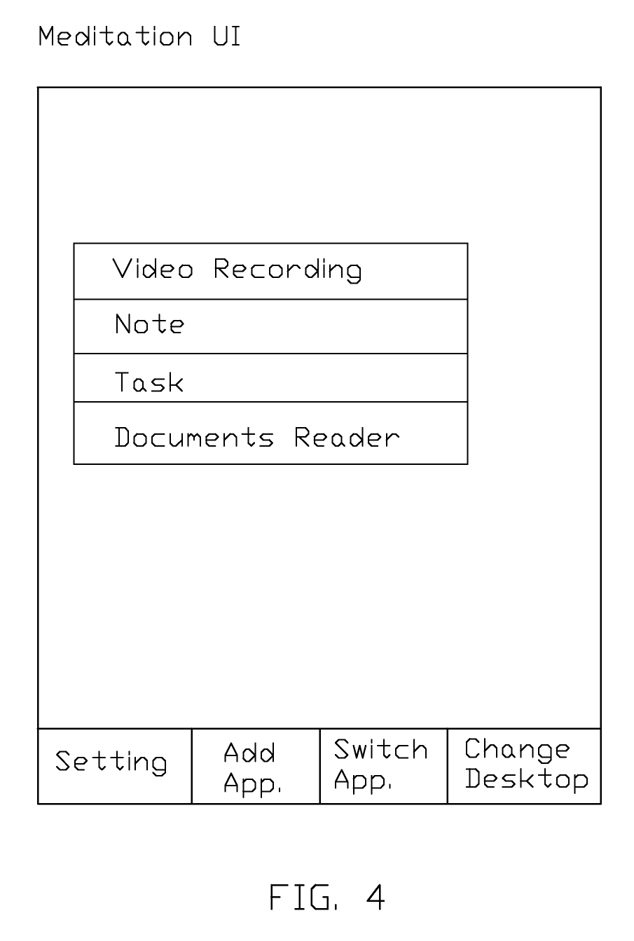

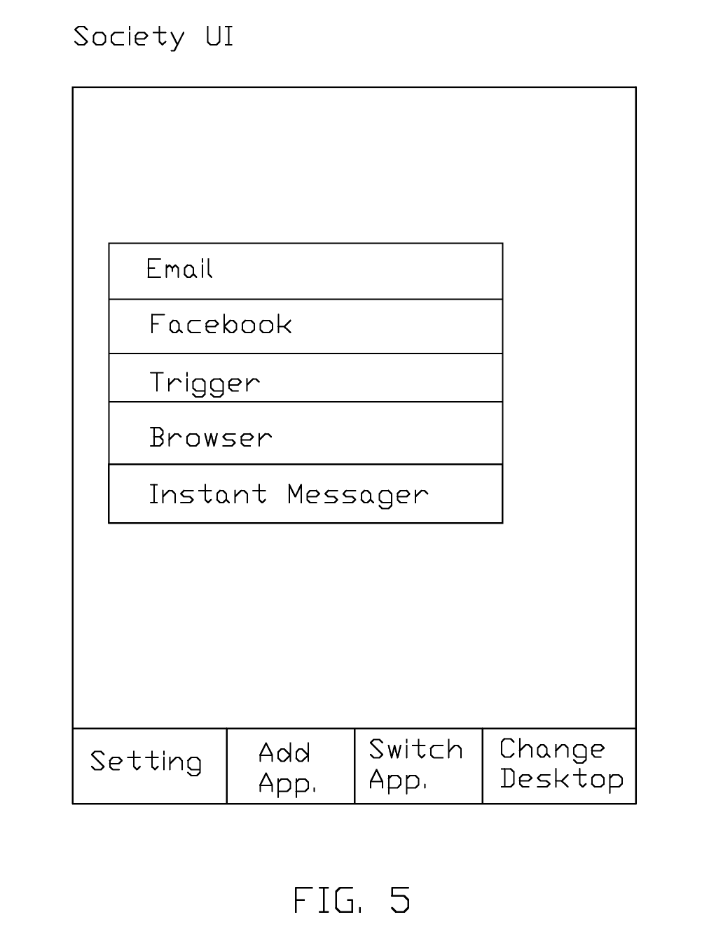

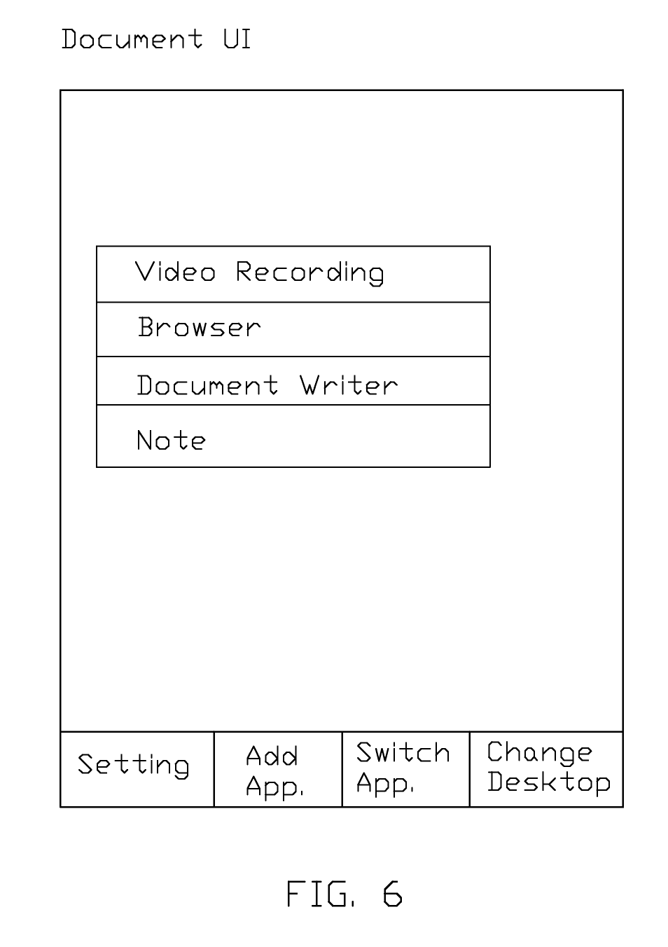

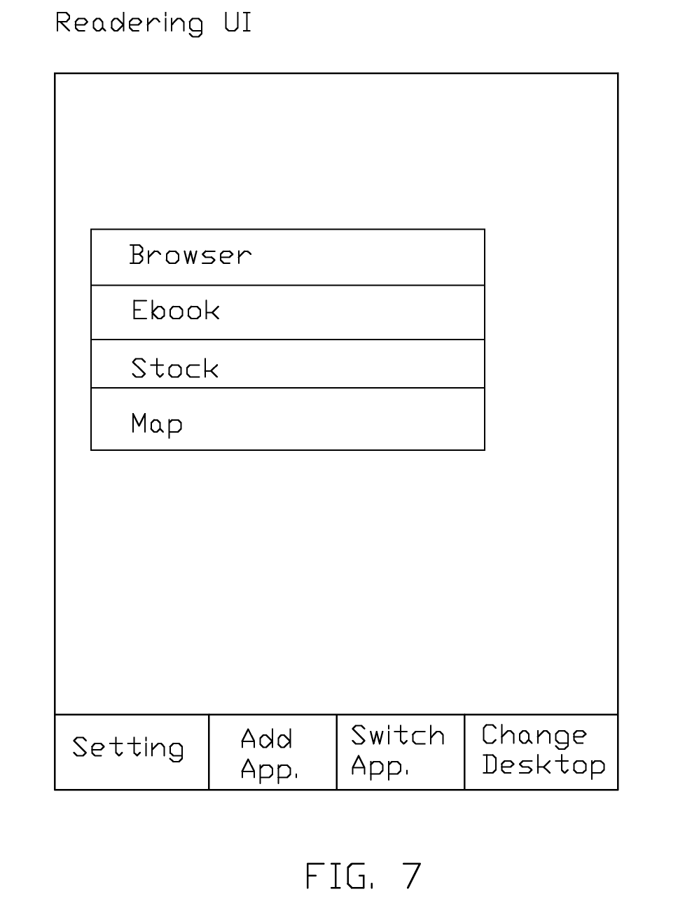

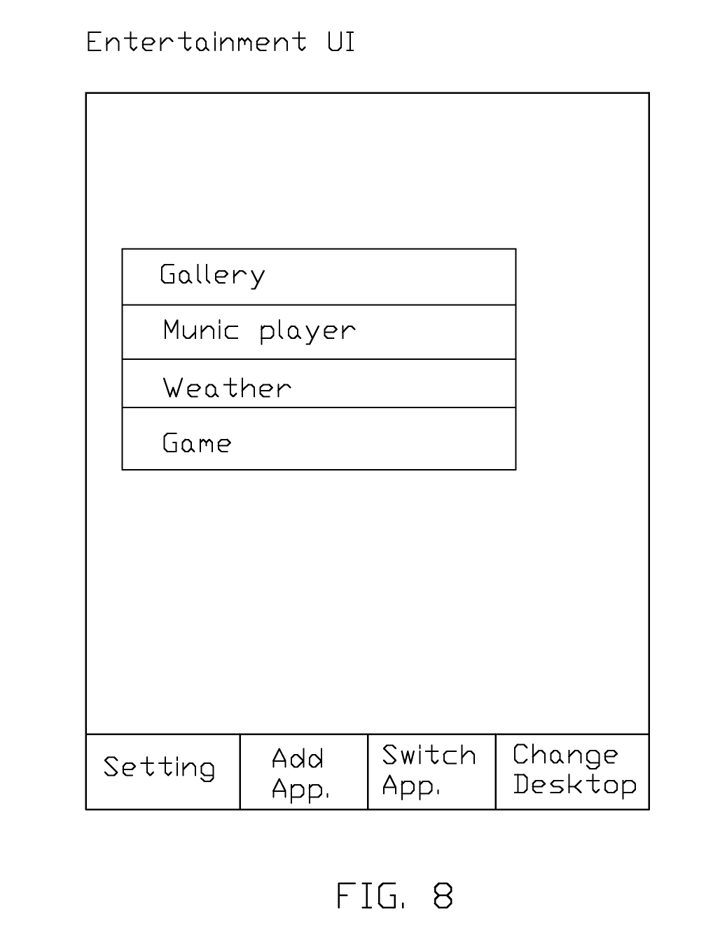

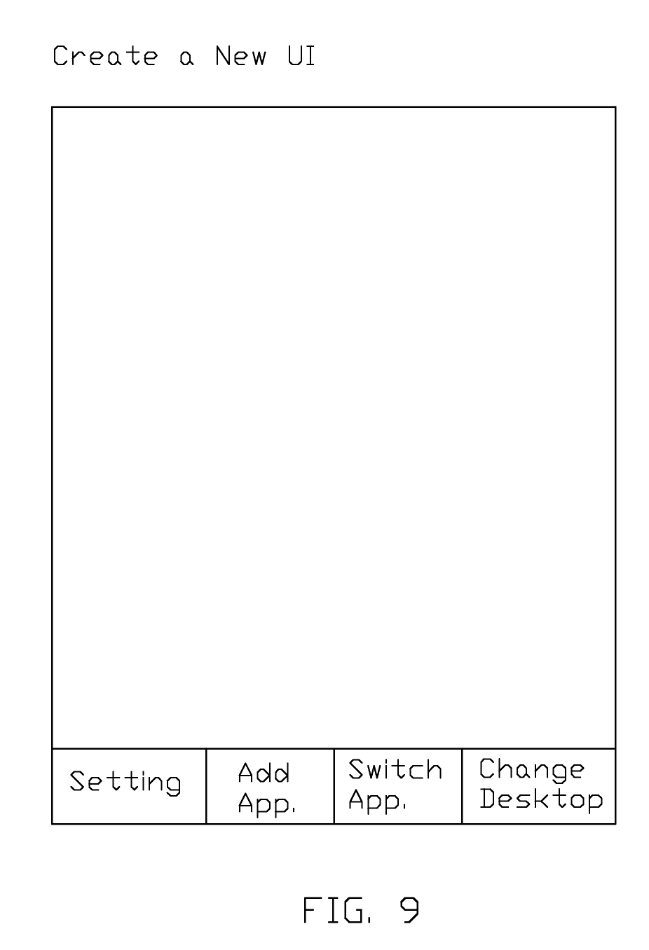

Referring to FIG. 4 through FIG. 9, other exemplarily UI's are shown on the display 10.

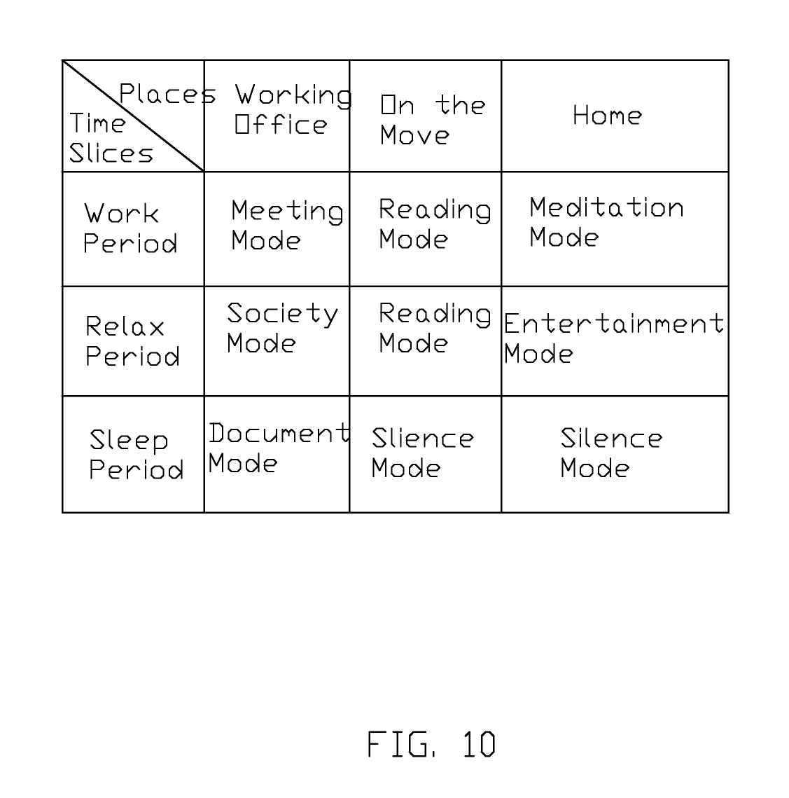

Referring to FIG. 10, in one embodiment, the timer 40 may calculate and record the current time. The timer 40 may be a clock. When the time corresponds to an event and one registered network connection device is detected, the electronic device may invoke a corresponding the corresponding UI module. One switch rule is shown in FIG. 10 in one embodiment. The location-positioning module 30 may enter a working mode based on either the location, the time, or the location and the time corporately.

Alternatively, if the location is detected through the globe-positioning sub-module, a manner of wireless connection may be selected from an accessible wireless connection list based on the location, for example, when home is detected, the home Wi-Fi network is considered to be used irrespective of mobile network. In this way, the plurality of working modes may use a different network selected from Wi-Fi network and mobile phone network.

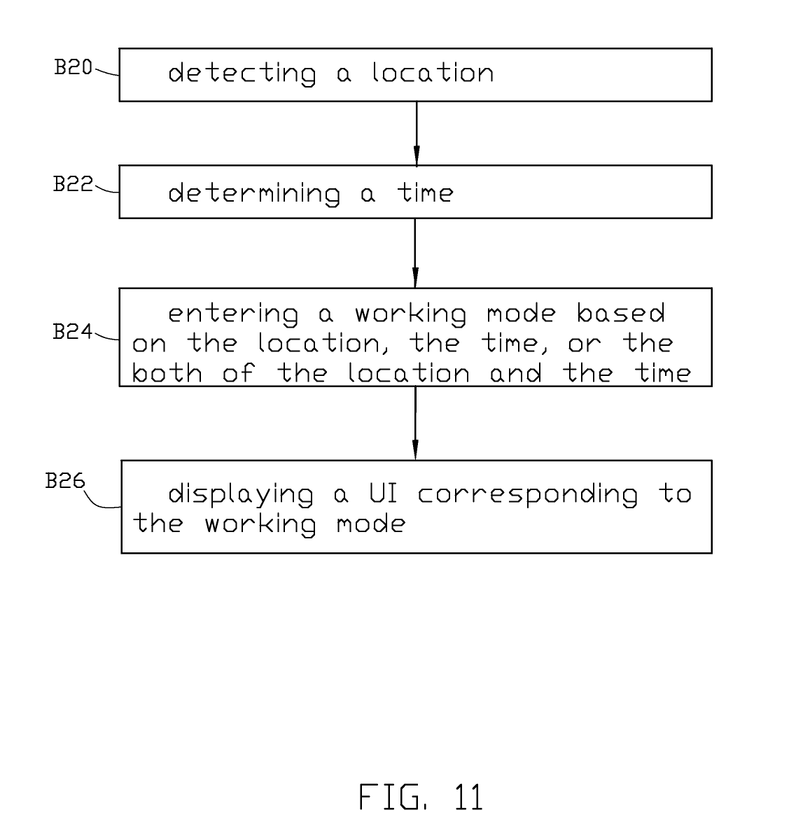

Referring to FIG. 11, a computer-implemented method for controlling the working mode of an electronic device may include the following steps:

Block B20, detecting the location by the location-positioning module.

Block B22, determining the time by the timer.

Block B24, entering a working mode based on the location, the time, or both the location and the time.

Block B26, displaying a user interface (UI) corresponding to the working mode. Labeling the current working mode by UI.

While the present disclosure has been illustrated by the description of the embodiments thereof, and while the embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device, comprising:
a display;
a location-positioning module adapted to detect a location;
a timer adapted to determine a time; and
a storage unit, comprising:
a mode switch module adapted to control a current working mode based on the location, the time, or both the time and the location.

2. The electronic device of the claim 1, wherein the storage unit further comprises a plurality of user interface (UI) modules, and each of the plurality of UI modules is associated with a pre-defined location, a pre-defined time, or both the pre-defined location and the pre-defined time.

3. The electronic device of the claim 2, wherein each of the plurality of UI modules has a different appearance when displayed.

4. The electronic device of the claim 1, wherein the location-positioning module is adapted to detect the location through a globe-positioning sub-module.

5. The electronic device of the claim 1, wherein the location-positioning module is adapted to detect the location through an accessible wireless network connection device.

6. The electronic device of the claim 5, wherein the accessible wireless network connection device is connected through a network connection based on IEEE 802.11 standard.

7. A computer-implemented method for controlling a working mode of an electronic device comprising:
detecting a location;
determining a time; and
entering a current working mode based on the location, time, or both the location and the time.

8. The method of the claim 7 further comprising displaying a user interface (UI) corresponding to the current working mode.

9. The method of the claim 8 further comprising the UI labeling the current working mode.

10. The method of the claim 7 further comprising detecting the current location through a globe-positioning sub-module.

11. The method of the claim 7, wherein the detecting the current location further comprises detecting the location through an accessible wireless network connection device

12. The method of the claim 11, wherein the accessible wireless network connection device is connected through a network connection based on IEEE 802.11 standard.

13. A computer-implemented method for controlling a working mode of an electronic device comprising:
providing a display; a location-positioning module adapted to detect a location; a timer adapted to determine time; and a storage unit; the storage unit comprising a mode switch module; wherein the mode switch module is adapted to control a current working mode based on the location, the time, or both the location and the time;
detecting the location;
determining the time; and
entering the current working mode based on the location, the time, or both the location and the time.
